(19) United States
(12) Patent Application Publication
(10) Pub. No.: US 2015/0138259 A1
(43) Pub. Date: May 21, 2015

(54) DRIVING DEVICE FOR DRIVING DISPLAY UNIT

(71) Applicant: LAPIS Semiconductor Co., Ltd., Yokohama (JP)

(72) Inventors: Akira NAKAYAMA, Yokohama (JP); Hideaki HASEGAWA, Yokohama (JP)

(73) Assignee: LAPIS SEMICONDUCTOR CO., LTD., Yokohama (JP)

(21) Appl. No.: 14/549,105

(22) Filed: Nov. 20, 2014

(30) Foreign Application Priority Data
Nov. 21, 2013 (JP) 2013-241070

(51) Int. Cl. G06F 1/32; G09G 3/20

(52) U.S. Cl. CPC G06F 1/3265; G09G 3/2092; G09G 2310/0254; G09G 2310/0278; G09G 2330/023
USPC 345/691

(57) ABSTRACT

A device and method for controlling a semiconductor memory capable of suppressing deterioration in reliability of read-out data are provided. A drive controller generates pixel data sequence signals which indicate luminance levels of respective pixels based on a video data signal. A data driver generates pixel drive voltages corresponding to the luminance levels of the respective pixels on the basis of the pixel data sequence signals, and supplies the pixel drive voltages to data lines of the display unit. When the video data signal of one frame matches or substantially coincides with the video data signal of another frame which is directly succeeding to the particular one frame in time sequence, supply of the pixel data sequence signals to the data driver is stopped.

### BACKGROUND OF THE INVENTION

1. Field of the Invention

The present invention relates to a driving device for driving a display unit by supplying a video signal thereto, which displays an image, corresponding to the video signal.

2. Background Art

A portable communication terminal, which may be either one of portable telephones, smartphones, tablet computers, notebook computers, navigation devices, and portable game machines, is nowadays popular and usually includes a display unit, such as a liquid crystal display panel or an organic electro-luminescence (EL) unit. The portable communication terminal employs either one of various kinds of power saving technologies in order to reserve continuous operation time of batteries. As one of the power-saving technologies, an image input processing method has been proposed (see, for example, Japanese Patent Application Laid-Open No. 2006-184357). The method includes: determining whether an input image is a moving image or a still image on the basis of inputted frame-based video data; and inhibiting the inputted video data of a current frame from being supplied to a frame memory if the input image is a still image so as to reduce power consumption.

However, the above-described driving method merely omit a step of writing pixel data onto the frame memory, and therefore sufficient reduction in power consumption have not been achieved yet.

### SUMMARY OF THE INVENTION

An object of the present invention is to provide a driving device for driving a display unit with a reduced power consumption rate.

A driving device for driving a display unit according to the present invention is configured to drive a display unit in response to a video data signal applied thereto. The driving device includes: a drive controller configured to generate pixel data sequence signals which indicate luminance levels of respective pixels based on the video data signal and supply the generated pixel data sequence signals to the succeeding stage; and a data driver configured to generate pixel drive voltages corresponding to the luminance levels of the respective pixels on the basis of the pixel data sequence signals and to supply the generated pixel drive voltages to data lines of the display unit, wherein when the video data signal of one frame matches or substantially coincides with the video data signal of another frame which is directly succeeding to the particular one frame in time sequence, the drive controller stops supply of the pixel data sequence signals to the data driver.

### BRIEF DESCRIPTION OF THE ACCOMPANYING DRAWINGS

FIG. 1 is a block diagram illustrating a driving device for driving a display unit according to the present invention;

FIG. 2 is a time chart illustrating changes of signals generated by the driving device during a frame display period;

FIG. 3 is a time chart illustrating a changes of polarity switching signal POL;

FIG. 4 is a block diagram illustrating an internal configuration of a data driver 13;

FIG. 5 is a time chart illustrating changes of signals in the operation of the driving unit according to the present invention; and

FIG. 6 is a time chart illustrating another example of changes of signals in the operation of the driving device according to the present invention; and

FIG. 7 is a flow chart illustrating a routine of frame coincidence determination performed by the drive controller.

### DETAILED DESCRIPTION OF THE INVENTION

Hereinbelow, embodiments of the present invention will be described in detail while referring to the accompanying drawings.

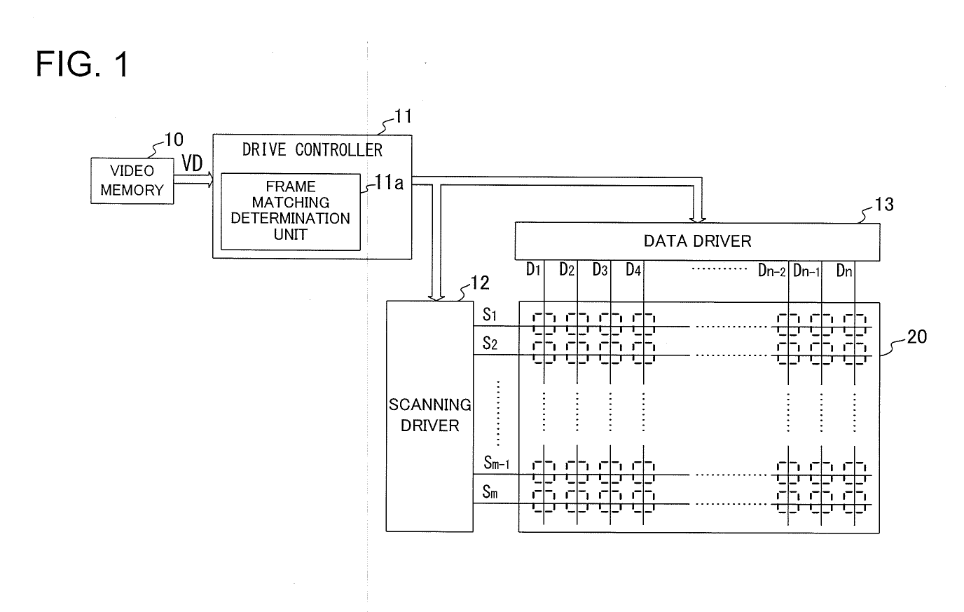

FIG. 1 is a schematic configuration view illustrating a a driving device for driving a display unit according to the present invention. As illustrated in FIG. 1, the display apparatus includes a video memory 10, a drive controller 11, a scanning driver 12, a data driver 13, and a liquid crystal or organic EL display unit 20.

The display unit 20 has m (m is a natural number of 2 or more) horizontal scan lines S₁ to Sₘ formed to extend in a horizontal direction on a two-dimensional screen and n (n is a natural number of 2 or more) data lines D₁ to Dₙ formed to extend in a vertical direction on the two-dimensional screen. Display cells carrying pixels are respectively formed at intersection areas between the horizontal scan lines and the data lines, i.e., in the areas encircled by rectangular broken lines in FIG. 1.

The video memory 10 stores video data signals provided by various application software (hereinafter referred to as AP) or video data signals received with a television tuner and the like. The video memory 10 reads out the stored video data signals, and supplies the data to the drive controller 11 as a video data signal VD.

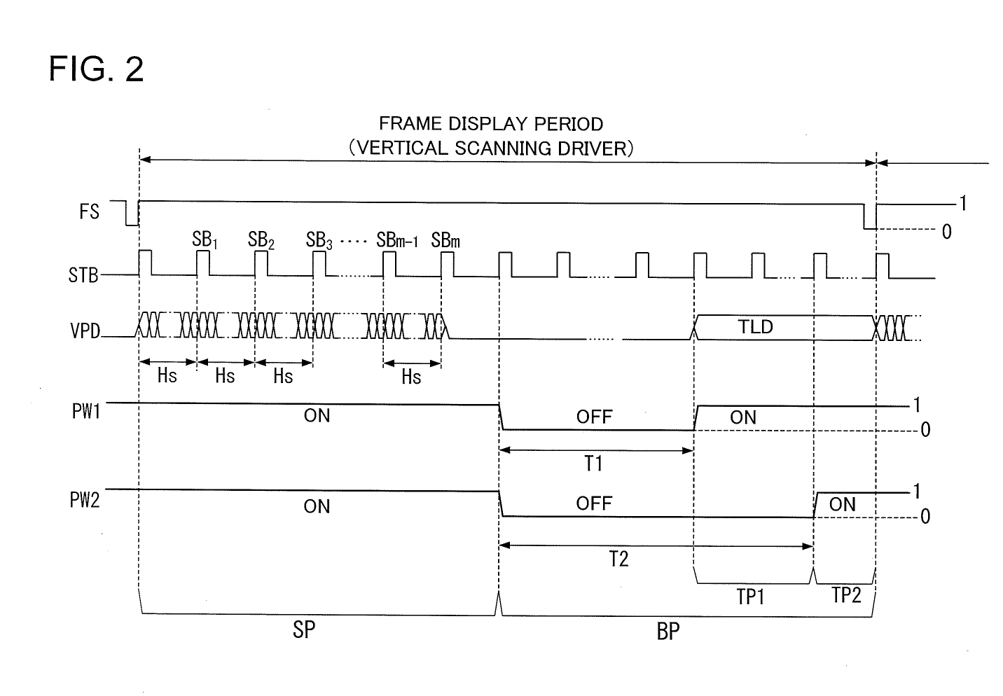

The drive controller 11 generates a sequence (line) of pixel data PD on the basis of the video data signal VD read out from the video memory 10. The sequence of pixel data PD indicates the luminance levels of the respective pixels with a bit string of, for example, 8 bits. A reference timing signal that indicates reference timing of a clock signal is superimposed on the sequence of pixel data PD to obtain pixel data sequence signals VPD. The pixel data sequence signals VPD are supplied to the data driver 13. Based on the video data signal VD, the drive controller 11 generates vertical sync signals FS that are synchronized with the frame of each image as illustrated in FIG. 2. The vertical sync signals FS are supplied to the data driver 13.

As illustrated in FIG. 2, in response to the video data signal VD, the drive controller 11 generates a strobe signal STB which is formed of a sequence of strobe pulses SB indicating horizontal scanning timing for the display unit 20. The strobe signal STB is supplied to the scanning driver 12 and the data driver 13. Therefore, the cycle of the strobe pulses SB in the strobe signal STB is equal to a horizontal scanning cycle Hs of horizontal scanning pulses (described later) which are applied to drive the display unit 20. As illustrated in FIG. 2, in each frame display period (vertical scanning period), a period from supplying a first strobe pulse SB₁ corresponding to a scan line S₁ to supplying an m-th strobe pulse SBₘ corresponding to a scan line Sₘ is defined as a data scanning period SP, and a subsequent period is defined as a blank period BP. In the data scanning period SP, the drive controller 11 generates power switch signals PW1 and PW2 of logic level 1 that is, for example, to assert continued power supply as illustrated in FIG. 2. The signals PW1 and PW2 are supplied to the data driver 13. When the data scanning period SP is switched to the blank period BP as illustrated in FIG. 2, the drive controller 11 supplies to the data driver 13 a power switch signal PW1 of logic level O that is, for example, to stop power supply for a predetermined power stop period T1 starting at the moment of switchover. The drive controller 11 then returns the power switch signal PW1 to the state of the logic level 1. When the data scanning period SP is switched to the blank period BP, the drive controller 11 supplies a power switch signal PW2 of logic level O to the data driver 13 to stop power supply for predetermined power stop period T2 (T2>T1) starting from the moment of switchover. The drive controller 11 then returns the power switch signal PW2 to the state of the logic level 1. As illustrated in FIG. 2, at the moment when the power stop period T1 has been lapsed after the start of the blank period BP, the drive controller 11 generates pixel data sequence signals VPD including a data sequence TLD for clock synchronization training, which is formed by superimposing the above-described reference timing signal on a dummy pixel data sequence. The generated pixel data sequence signals VPD are supplied to the data driver 13.

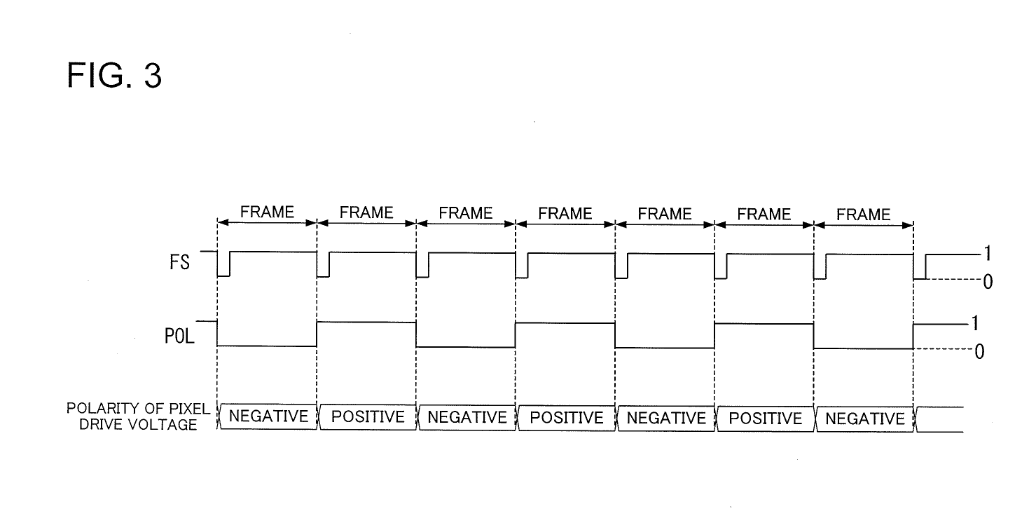

The drive controller 11 also generates a polarity switching signal POL which switches the polarity of pixel drive voltages applied to the display unit 20, from positive polarity to negative polarity, or from negative polarity to positive polarity, for each frame as illustrated in FIG. 3 for example. The generated polarity switching signal POL is supplied to the data driver 13. For example, as illustrated in FIG. 3, the polarity of the pixel drive voltage switches from negative polarity to positive polarity or from positive polarity to negative polarity at the timing of a rising edge or a falling edge of the polarity switching signal POL. The drive controller 11 includes a frame matching determination unit 11a that determines whether video data of one frame is identical to video data of another frame which is directly succeeding to the particular one frame in time sequence on the basis of the video data signal VD. The scanning driver 12 generates horizontal scanning pulses having a predetermined peak voltage in synchronization with each strobe pulse in the strobe signal STB supplied from the drive controller 11. The scanning driver 12 sequentially applies the horizontal scanning pulses to each of the scan lines S₁ to Sₘ of the display unit 20 in an alternative way.

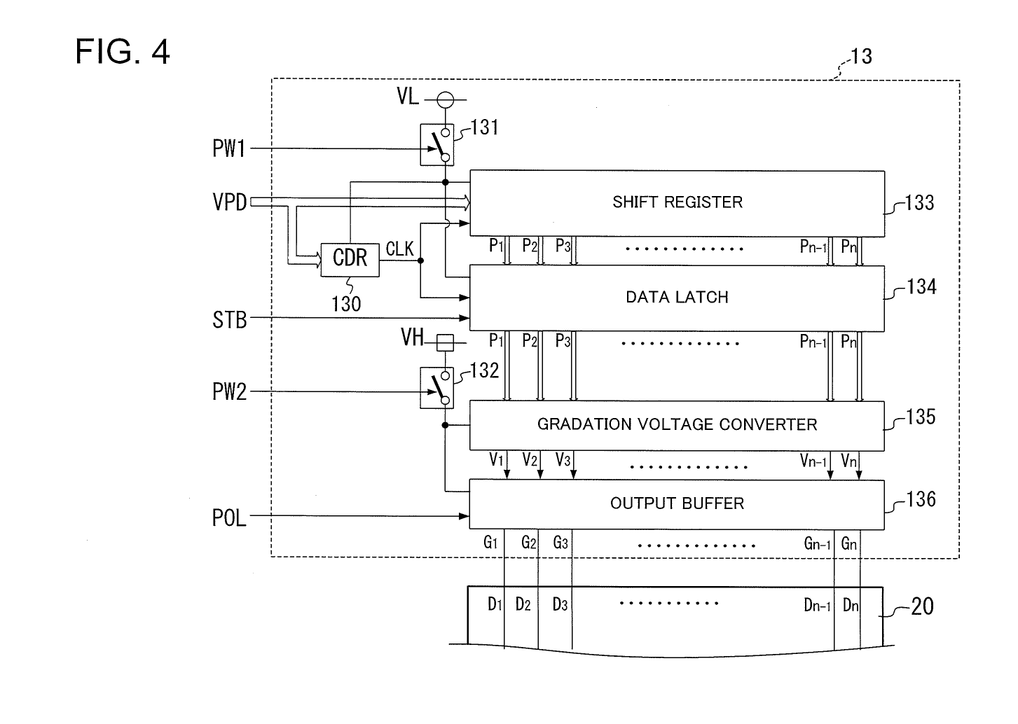

FIG. 4 is a block diagram illustrating the internal configuration of the data driver 13. As illustrated in FIG. 4, the data driver 13 includes a clock data recovery (hereinafter referred to as CDR) circuit 130, power switches 131 and 132, a shift register 133, a data latch 134, a gradation voltage converter 135, and an output buffer 136.

The CDR circuit 130 extracts a reference timing signal from the pixel data sequence signal VPD supplied from the drive controller 11. The CDR circuit 130 then generates a clock signal CLK in phase-synchronization with the reference timing signal, and supplies it to the shift register 133 and the data latch 134.

The power switch 131 is in an ON state while the power switch signal PW1 of logic level 1 that is, for example, to assert continued power supply is being supplied. Consequently, a source voltage VL for driving digital circuits is supplied to the CDR circuit 130 as well as to the shift register 133 and the data latch 134 which serve as a data taking unit. During this time, the CDR circuit 130, the shift register 133, and the data latch 134 are in an operable state in response to the supply of the source voltage VL. While the power switch signal PW1 of logic level 0 that is, for example, to stop power supply is being supplied, the power switch 131 is in an OFF state. Consequently, supply of the source voltage VL to the CDR circuit 130, the shift register 133, and the data latch 134 is stopped. During this time, the CDR circuit 130, the shift register 133, and the data latch 134 are in an operation stopped state.

The power switch 132 is in the ON state while the power switch signal PW2 of the logic level 1 that is, for example, to assert continued power supply is being supplied from the drive controller 11. Consequently, a source voltage VH for driving pixels is supplied to the gradation voltage converter 135 and the output buffer 136 which serve as a pixel drive voltage outputting unit. During this time, the gradation voltage converter 135 and the output buffer 136 are in the operable state in response to the supply of the source voltage VH. While the power switch signal PW2 of, for example, logic level 0 that is to stop power supply is being supplied, the power switch 132 is in the OFF state. Consequently, supply of the source voltage VH to the gradation voltage converter 135 and the output buffer 136 is stopped. During this time, the gradation voltage converter 135 and the output buffer 136 are in the operation stopped state.

The shift register 133 sequentially takes in pixel data PD corresponding to each pixel at a timing synchronized with the clock signal CLK, from the pixel data sequence signals VPD supplied from the drive controller 11. Whenever data of one horizontal scan line (n data sets) is taken in, the shift register 133 supplies n sets of pixel data PD to the data latch 134 as pixel data P₁ to Pₙ.

In response to the strobe signal STB illustrated in FIG. 2, the data latch 134 takes in the pixel data P₁ to Pₙ supplied from the shift register 133 at a timing synchronized with the clock signal CLK, and supplies these data sets to the gradation voltage converter 135.

The gradation voltage converter 135 converts the pixel data P₁ to Pₙ supplied from the data latch 134 into pixel drive voltages V₁ to Vₙ that have voltage values corresponding to the luminance levels of the respective pixels, and supplies the pixel drive voltages V₁ to V to the output buffer 136.

The output buffer 136 switches the polarity of the respective pixel drive voltages V₁ to Vₙ from positive polarity to negative polarity or from negative polarity to positive polarity at an edge timing of the polarity switching signal POL supplied from the drive controller 11. The output buffer 136 switches the polarity of the pixel drive voltage in each pixel as described above and then amplifies each of the pixel drive voltages to a desired level. Thus-generated pixel drive voltages G₁ to Gₙ are applied to data lines D₁ to Dₙ of the display unit 20.

As illustrated in FIG. 2, during the data scanning period SP in each of the frame display periods in the display unit 20, scanning pulses in synchronization with the respective strobe pulses SB₁ to SBₘ are sequentially applied to the scan lines S₁ to Sₘ in an alternative way. As a result, a picture corresponding to the pixel drive voltages G₁ to Gₙ is displayed one scan line at a time in order.

Hereinbelow, the operation of the driving device including the above-described drive controller 11 and data driver 13 will be described.

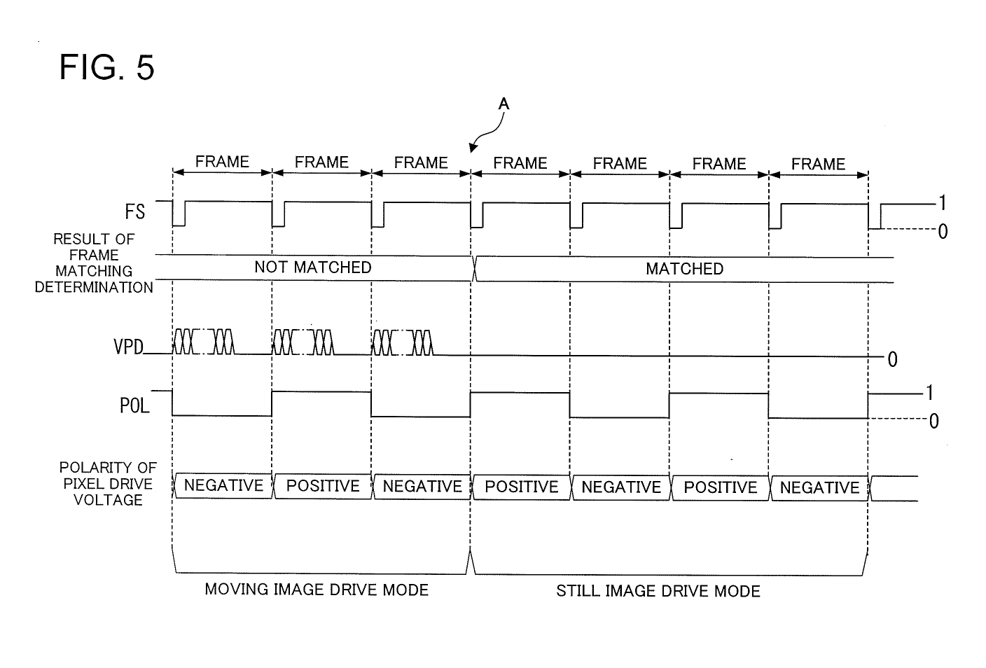

As long as the frame matching determination unit 11a determines that video data of one frame does not match nor substantially coincide with the video data of another frame which is directly succeeding to the particular one frame in time sequence, in other words, when pictures represented by the video data signal VD are moving images, the drive controller 11 executes the above-described control in accordance with FIGS. 2 and 3 (moving image drive mode) as illustrated in FIG. 5. When the frame matching determination unit 11a determines that a video data of one frame matches or substantially coincides with the video data of another frame which is directly succeeding to the particular one frame in time sequence, in other words, when pictures represented by the video data signal VD are still images, the drive controller 11 performs drive control in accordance with the following still image drive mode.

In the still image drive mode, the drive controller 11 stops supply of the pixel data sequence signals VPD to the data driver 13 from a timing A as illustrated in FIG. 5. Accordingly, in the shift register 133 and the data latch 134 of the data driver 13, the logic level is not changed by the pixel data sequence signals VPD. As a result, a current which flows in response to such change in logic level substantially becomes zero. Since the shift register 133 and the data latch 134 stop operation, reduction in power consumption is achieved.

When the display unit 20 is, for example, a liquid crystal display device, ghosting of images on the screen may occur due to such factors as deterioration in liquid crystal materials. In order to prevent the ghosting of images, an embodiment illustrated in FIG. 5 is configured to reverse the polarity of the pixel drive voltages G₁ to Gₙ in each frame both in the moving image drive mode and the still image drive mode.

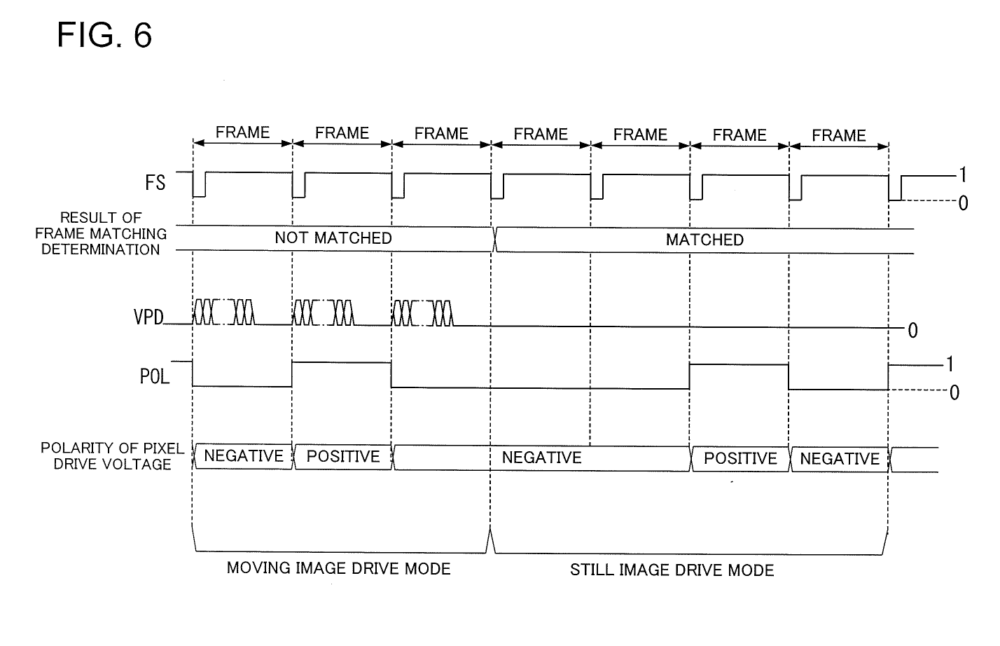

However, in the still image drive mode, the operation to reverse the polarity of the pixel drive voltages G₁ to Gₙ may temporarily be stopped and the polarity may be fixed as illustrated in FIG. 6. More specifically, when the driving mode is shifted from the moving image drive mode to the still image drive mode, the drive controller 11 fixes the logic level of the polarity switching signal POL for a display period of, for example, 2 frames so as to omit one polarity reversal operation as illustrated in FIG. 6. During this period, the processing to reverse the polarity of the voltages is not performed in the output buffer 136 of the data driver 13. Therefore, power consumption can proportionally be reduced. Although the polarity of the pixel drive voltages are fixed for a display period of 2 frames in the example illustrated in FIG. 6, the polarity of the pixel drive voltages is not necessarily fixed for the display period of 2 frames in the still image drive mode. In other words, as long as the period is short enough for the display unit 20 to prevent ghosting of images, the polarity of the pixel drive voltages may be fixed for a predetermined display period of 3 or more frames.

In the examples illustrated in FIGS. 5 and 6, the polarity of the pixel drive voltages are reversed in each display period of 1 frame in the moving image drive mode. However, the polarity of the pixel drive voltages may be reversed in each display period of 2 frames or more, i.e., in each display period of N frames (N is an integer). In this case, in the still image drive mode, the polarity of the pixel drive voltages is fixed for a display period of K frames (K is an integer larger than N).

In the examples illustrated in FIGS. 5 and 6, the polarity of the pixel drive voltages of one frame is uniformly switched from positive polarity to negative polarity or from negative polarity to positive polarity. However, the configuration of switching the polarity is not limited thereto. For example, the output buffer 136 may set the polarity of pixel drive voltages G₁ to Gₙ, which correspond to odd-numbered horizontal scan lines S, to be positive (or negative) and set the polarity of pixel drive voltages G₁ to Gₙ, which correspond to even-numbered horizontal scan lines S, to be negative (or positive) and reverse the set polarity in response to the polarity switch signal POL. The output buffer 136 may also set the polarity of a pixel drive voltage G corresponding to an odd-numbered data line D, among the pixel drive voltages G₁ to Gₙ, to be positive (or negative), and may set the polarity of a pixel drive voltage G corresponding to an even-numbered data line D to be negative (or positive) and reverse the set polarity in response to the polarity switching signal POL.

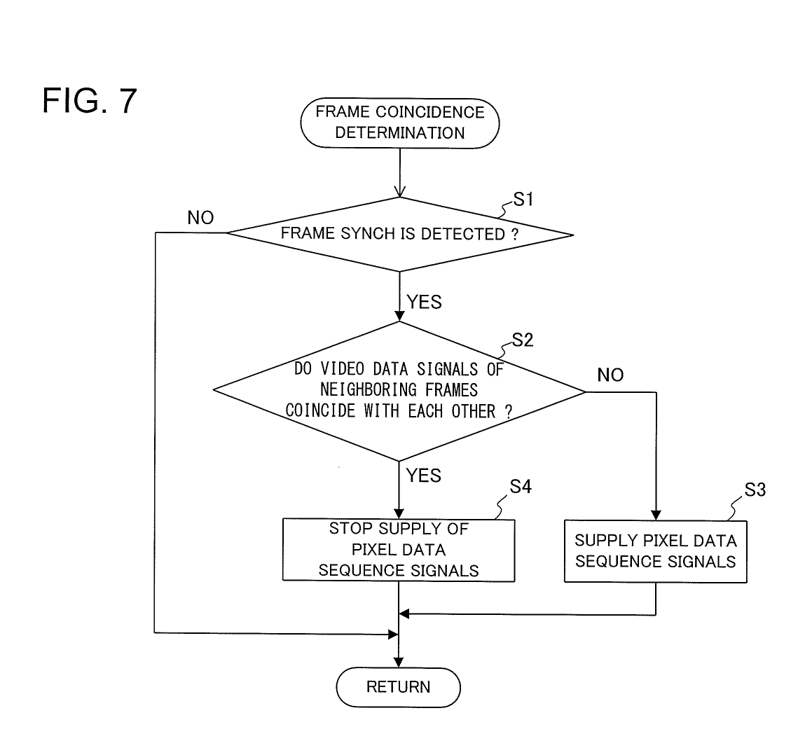

The drive controller 11 may be one that performs the routine as shown in FIG. 7. That is, when detecting the frame synchronization at Step S1, the frame matching determination unit 11a determines whether the video data signal of one frame matches or substantially coincides with the video data signal of another frame which is directly succeeding to the particular one frame in time sequence or not at Step S2. If it is determined that they are not matched nor substantially coincided, the drive controller supplies a pixel data sequence signals to the data driver at Step S3. If it is determined that they are matched or substantially coincided, the drive controller stops supply of the pixel data sequence signals to the data driver at Step S4.

As described in the foregoing, the driving device according to the present invention includes: a drive controller (11) configured to generate pixel data sequence signals (VPD) which indicate luminance levels of respective pixels based on the video data signal (VD); and a data driver (13) configured to generate pixel drive voltages (G) corresponding to the luminance levels of the respective pixels on the basis of the pixel data sequence signals and to supply the generated pixel drive voltages to data lines (D) of the display unit (20). When the video data signal of one frame matches or substantially coincides with the video data signal of another frame which is directly succeeding to the particular one frame in time sequence, the drive controller stops supply of the pixel data sequence signals to the data driver so as to achieve reduction in power consumption. In the driving device, when the data driver reverses the polarity of the pixel drive voltages in a periodic basis (in each display period of N frames), the polarity of the pixel drive voltages is fixed by the output buffer 136 for a predetermined period (display period of K frames (N<K)) if the video data of one frame matches or substantially coincides with the video data of another frame which is directly succeeding to the particular one frame in time sequence. This allows further reduce in power consumption.

This application is based on a Japanese Patent application No. 2013-241070 which is hereby incorporated by reference.

What is claimed is:

1. A driving device for driving a display unit in response to a video data signal, the driving device comprising:
a drive controller configured to generate pixel data sequence signals which indicate luminance levels of respective pixels based on the video data signal and supply the generated pixel data sequence signals to the succeeding stage; and
a data driver configured to generate pixel drive voltages corresponding to the luminance levels of the respective pixels on the basis of the pixel data sequence signals and to supply the generated pixel drive voltages to data lines of the display unit, wherein
the drive controller stops supply of the pixel data sequence signals to the data driver, when the video data signal of one frame matches or substantially coincides with the video data signal of another frame which is directly succeeding to the particular one frame in time sequence.

2. The driving device for driving a display unit according to claim 1, wherein
the data driver reverses polarity of the pixel drive voltages in each display period of N (N is an integer) frames, and
when the video data signal of one frame matches or substantially coincides with the video data signal of another frame which is directly succeeding to the particular one frame in time sequence, the drive controller controls the data driver so as to fix the polarity of the pixel drive voltage for a predetermined period.

3. The driving device for driving a display unit according to claim 2, wherein, when the video data signal of one frame matches or substantially coincides with the video data signal of another frame which is directly succeeding to the particular one frame in time sequence, the drive controller fixes the polarity of the pixel drive voltages for a display period of K (K is an integer and larger than N) frames.

4. The driving device for driving a display unit according to claim 2, wherein the polarity of the pixel drive voltages corresponding to odd-numbered horizontal scan lines in the display unit is different from the polarity of the pixel drive voltages corresponding to even-numbered horizontal scan lines.

5. The driving device for driving a display unit according to claim 3, wherein the polarity of the pixel drive voltages corresponding to odd-numbered horizontal scan lines in the display unit is different from the polarity of the pixel drive voltages corresponding to even-numbered horizontal scan lines.

6. The driving device for driving a display unit according to claim 2, wherein the polarity of the pixel drive voltages corresponding to odd-numbered data lines in the display unit is different from the polarity of the pixel drive voltages corresponding to even-numbered data lines.

7. The driving device for driving a display unit according to claim 3, wherein the polarity of the pixel drive voltages corresponding to odd-numbered data lines in the display unit is different from the polarity of the pixel drive voltages corresponding to even-numbered data lines.
